(19) United States
(12) Patent Application Publication
(10) Pub. No.: US 2013/0226329 A1
(43) Pub. Date: Aug. 29, 2013

(54) Cleanspace Fabricators for High Technology Manufacturing and Assembly Processing

(71) Applicant: Frederick A. Flitsch, New Windsor, NY (US)

(72) Inventor: Frederick A. Flitsch, New Windsor, NY (US)

(21) Appl. No.: 13/734,963

(22) Filed: Jan. 5, 2013

Related U.S. Application Data
(63) Continuation-in-part of application No. 11/933,280, filed on Oct. 31, 2007.
Application No. 11/933,280 is a continuation-in-part of application No. 13/398,371, filed on Feb. 16, 2012.
Application No. 13/398,371 is a continuation-in-part of application No. 11/502,689, filed on Aug. 12, 2006.
(60) Provisional application No. 61/585,368, filed on Jan. 11, 2012.

(51) Int. Cl. G05D 3/00

(52) U.S. Cl. CPC G05D 3/00
USPC 700/112

(57) ABSTRACT

The present invention provides various aspects for processing multiple types of substrates within cleanspace fabricators or for processing multiple or single types of substrates in multiple types of cleanspace environments. In some embodiments, a collocated composite cleanspace fabricator may be capable of processing semiconductor devices into integrated circuits and then performing assembly operations to result in product in packaged form.

### CROSS REFERENCE TO RELATED APPLICATIONS

This application claims priority to U.S. Provisional Patent Application bearing Ser. No. 61/585368, filed Jan. 11, 2012, entitled Cleanspace Fabricators for High Technology Manufacturing and Assembly Processing. This application is also continuation-in part to the United States Patent Applications bearing the Ser. No. 11/933,280 filed Oct. 31, 2007 and entitled Method and Apparatus for a Cleanspace Fabricator; and Ser. No. 11/520975, filed Sep. 14, 2006 and entitled Method and Apparatus for Vertically Orienting Substrate Processing Tools in a Cleanspace; and Ser. No. 11/502,689 filed Aug. 12, 2006 and entitled Method and Apparatus to Support a Cleanspace Fabricator and to any divisional or continuation patents thereto. The contents of each are relied upon and incorporated by reference.

### FIELD OF THE INVENTION

The present invention relates to apparatus and methods which support processing tools used in conjunction with cleanspace fabricators. More specifically, the present invention relates to fabricator designs which may be used to process high technology products and assemble them into a packaged form.

### BACKGROUND OF THE INVENTION

A known approach to advanced technology fabrication of materials, such as semi-conductor substrates, is to assemble a manufacturing facility as a “cleanroom.” In such cleanrooms, processing tools are arranged to provide aisle space for human operators or automation equipment. Exemplary cleanroom design is described in: “Cleanroom Design, Second Edition,” edited by W. Whyte, published by John Wiley & Sons, 1999, ISBN 0-471-94204-9, (herein after referred to as “the Whyte text”).

Cleanroom design has evolved over time from an initial starting point of locating processing stations within clean hoods. Vertical unidirectional airflow can be directed through a raised floor, with separate cores for the tools and aisles. It is also known to have specialized mini-environments which surround only a processing tool for added space cleanliness. Another known approach includes the “ballroom” approach, wherein tools, operators and automation all reside in the same cleanroom.

Evolutionary improvements have enabled higher yields and the production of devices with smaller geometries. However, known cleanroom design has disadvantages and limitations.

For example, as the size of tools has increased and the dimensions of cleanrooms have increased, the volume of cleanspace that is controlled has concomitantly increased. As a result, the cost of building the cleanspace, and the cost of maintaining the cleanliness of such cleanspace, has increased considerably. Not all processing steps, like for example the steps used to assembly products into their packaging, need to occur in the developing large processing environments.

Additionally, the processing of high technology products may typically be split into portions that require high levels of cleanliness in the manufacturing environment which are typically at the beginning of the processing and then steps like the assembly steps which have less critical contamination sensitive processing. In some cases these two types of processing steps may be processed in different facilities because of their different needs. Yet, in many small volume activities, the need for rapid processing of all steps to result in a product that can be utilized in its fully processed form may be important. It would therefore be useful to have an efficient processing fabricator design that can process the different types of steps of multiple cleanliness requirements in a single location with rapidity.

### SUMMARY OF THE INVENTION

Accordingly, building on the types of environments defined in previous patents, there are novel methods to form cleanspace fabricators which can process products in the high cleanliness and lower cleanliness requirements at the same time in efficient manners. As well, some of the processing steps will occur with substrates that are in a wafer form; while the later steps may occur in substrates which are cut outs from that wafer form. Accordingly, the present invention provides description of how the previously discussed strategies can be taken further to define cleanspace fabricator environments capable of processing high technology products from initial wafer substrate form to final packaging into products ready to be used in electronic devices.

The various type of processing tools can be placed with each port inside the first cleanspace and the body of each processing tool can be placed at a location peripheral to the cleanspace boundary wall, such that in some embodiments at least a portion of the tool body is outside the first cleanspace. In some embodiments, the substrate carriers that carry substrates while they move in the first cleanspace may be different for the different types of processing and the different types and sizes of substrates.

In some embodiments of the processing environment, a combination of multiple discrete but collocated cleanspace fabricators may be formed and used to process high technology substrates which start in wafer form and are later are substrates processed in forms related to pieces of the wafer form. A combination of multiple cleanspace fabricators which are joined but have separate primary cleanspace regions for the different forms of processing is also possible. In other forms, a cleanspace fabricator of one type may be combined with another of a different type for the two different types of substrate processing.

In a different type of embodiment, there may be only a single type of cleanspace fabricator which is populated by tools of the different type of substrate processing types. Since the cleanspace fabricator definitions result in efficient fabricators, it may be fine to move different types of substrates around in a primary cleanspace environment that is sufficient to process high cleanliness requirement processing steps and therefore is more cleanly than what is needed for the assembly operations. Since the substrates and the carriers that are used to move them around are different, in some embodiments the automation or robotics that is used to move the substrate carriers around the primary cleanspace may be different. Alternatively, a single robot type may have the capability of moving around different types of carriers.

The present invention can therefore include methods and apparatus for: processing high technology substrates of different types in collocated environments and forming products of different types in some embodiments including wafers in a complete form, and in some embodiments packaged electronic components.

### BRIEF DESCRIPTION OF THE DRAWINGS

The accompanying drawings, that are incorporated in and constitute a part of this specification, illustrate several embodiments of the invention and, together with the description, serve to explain the principles of the invention:

FIG. 1 Illustrates some exemplary cleanspace fabricators

FIG. 2 Illustrates an exemplary set of collocated cleanspace fabricators for different types of processing in a single location.

FIG. 3 Illustrates an exemplary embodiment where two different cleanspace environments are created in a single cleanspace fabricator design with an intermediate wall.

FIG. 4 Illustrates exemplary general shapes of cleanspace fabricators with their cleanspaces for annular tubular examples, sections of annual tubular and combinations of various cleanspace fabricators with different cleanspace environments.

FIG. 5 Illustrates an exemplary cleanspace fabricator for processing multiple types of substrates where a single cleanspace environment is utilized with multiple and varied types of automation.

FIG. 6 Illustrates examples depicting different types of substrate carriers that might be processed in different processing tools including a single wafer carrier, a multiple wafer carrier and an exemplary waffle pack carrier.

### DETAILED DESCRIPTION OF PREFERRED EMBODIMENTS

The present invention relates to methods and apparatus to process substrates of different types in cleanspace fabricator environments. In some exemplary embodiments of this type of processing, substrates in the form of wafers may be processed to create integrated circuits upon the substrate and then in subsequent processing the integrated circuits can be processed to result in a discrete integrated circuit in its packaging.

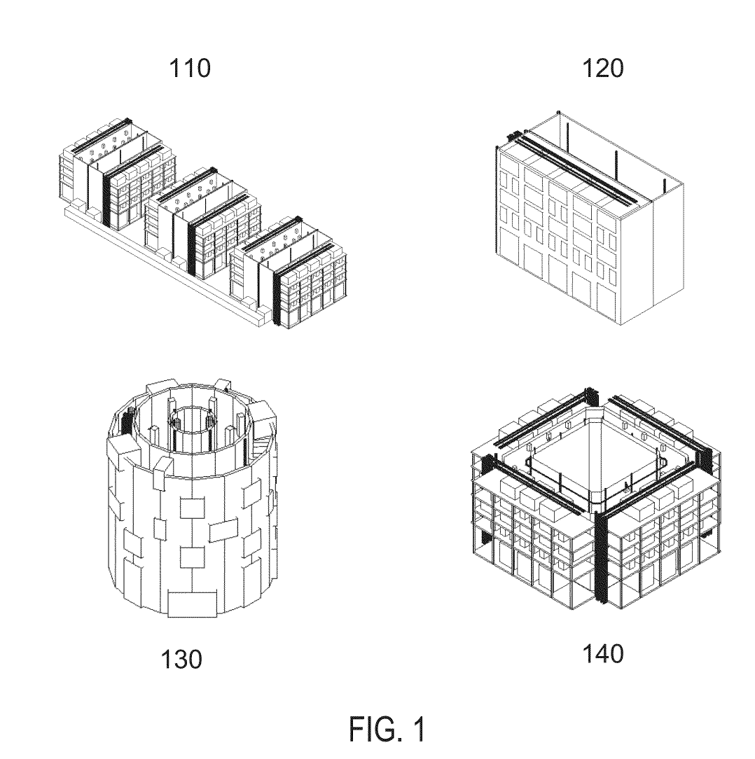

Cleanspace fabricators may come in numerous different types. Proceeding to FIG. 1, a number of exemplary cleanspace fabricators are depicted. In item 110, a fabricator is depicted which is made up of numerous essentially planar cleanspace fabricators elements which are connected together. In item 120, a single standalone planar cleanspace is depicted. Item 130, depicts a round tubular annular cleanspace fabricator type. And, item 140 depicts a square exemplary tubular annular cleanspace fabricator type. It may be apparent that many different variations on these fundamental types of fabricators are included in the general art of cleanspace fabricators. In these versions of fabricators, a common mode of operations would be for the fabricators to process wafer form substrates of one type from when the substrates enter the fabricator to when they leave it. A different embodiment type of these fabricators may derive if there are multiple types of substrates that are simultaneously being processed in the fabricator.

Fabricators with Semiconductor Wafer Processing Cleanspace Elements and Semiconductor Die Packaging Cleanspace Elements.

Significant generality has been used in describing cleanspace fabricators because there are numerous types of technology fabrication that are consistent with the art including in an exemplary sense the processing of semiconductor substrates, Microelectromechanical systems, “Lab on Chip” processing, Biochip processing, and many other examples including the processing of substrates which support device production or are incorporated into devices as they are produced. Without losing the generality and purely for exemplary purposes, some examples that relate to the processing of semiconductor substrates will be used to illustrate the inventive art being described.

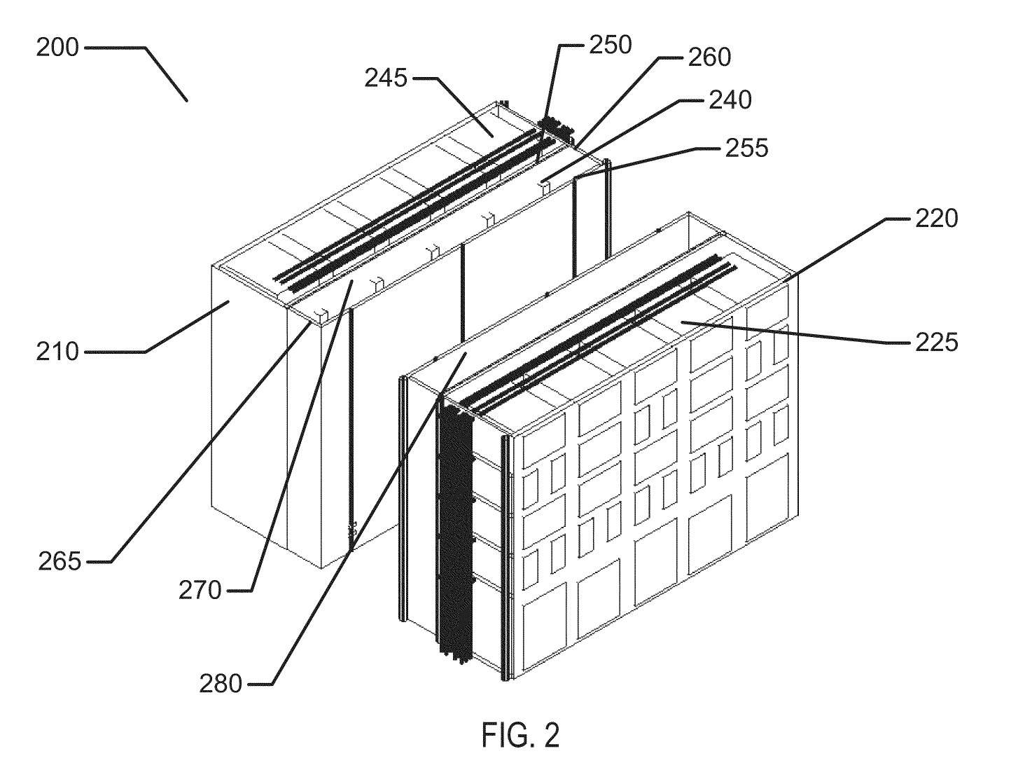

Proceeding to FIG. 2, item 200 two essentially planar cleanspace fabricator elements are depicted. Item 210 depicts a first cleanspace element, which in an exemplary sense, may show a cleanspace fabricator where the substrate type is semiconductor wafers and the equipment or tools used to process semiconductor wafers into integrated circuits on wafers may be depicted for example as item 245. Item 210 is a cleanspace fabricator, and one embodiment type of such a fabricator may have the following distinguishing characteristics. The fabricator has a cleanspace, item 270, which is bounded by walls which span numerous tooling levels. In some embodiments, items 250, 255, 260 and 265 may define walls surrounding the cleanspace 270. Within cleanspace 270, may be located the ports of various processing tools, for example, one of which is depicted as item 240. For that processing tool, on the other side of the cleanspace boundary, item 250, the body of the processing tool may be represented as item 245. In some embodiments, airflow to create the clean environment of the cleanspace may proceed in a unidirectional manner from and through wall 250 to and through wall 255. In other embodiments the direction of the flow may be reversed. In still other embodiments the flow may proceed from wall 250 to wall 255 but do so in a non-unidirectional manner. In some embodiments, walls 260 and 265 may simply be smooth faced walls which do not relate to the flow of air around them, alternatively the walls may either correspond to air source walls or to air receiving walls. As well, the nature of the air source walls may be defined by placing HEPA filters upon the wall and either flowing air through the wall and then through the HEPA Filters or alternatively flowing air to the HEPA filters and then flowing the air out of the filter surface into the cleanspace. There may be other embodiments of the cleanspace type where the airflow in unidirectional fashion or in non-unidirectional fashion may be flowed from the top of the cleanspace to the bottom. There may be numerous manners of defining the airflow within a cleanspace consistent with the art of cleanspace fabrication.

Within the cleanspace, item 270, there may be located automation which is capable of processing wafer carriers which contain the substrates to be processed. In an exemplary fashion, in embodiments where cleanspace fabricator element 210 is formed to process semiconductor wafers to create integrated circuits, the cleanliness requirements of the cleanspace fabricator may be significantly demanding. As shown in FIG. 2, the processing tools may be arranged in a vertical and horizontal manner which in some embodiments may be termed a matrix; that is where tools are generally located at discrete vertical heights or levels and then at various horizontal locations between two standard vertical limits. As the substrates are processed and various electrical elements such as in a non-limiting sense, transistors, resistors, and capacitors are formed and then electrically interconnected with conductive lines, at some point the device structure with its interconnections may be completed. The resulting wafer is an embodiment of one type of product of such operations in a cleanspace fabricator as are the individual results of each processing step. Yet the fully formed product may now have completed the time it needs to spend in the highly clean environment of cleanspace fabricator element 210. A wafer in such a completed form may then be ready to be further processed in manners that may require cleanspace processing but at a significantly less severe cleanliness requirement. As may be apparent, cleanspace fabricators provide an innovative manner to continue such processing. In some embodiments a similar essentially planar cleanspace fabricator, item 220 may be located in the general vicinity of fabricator 210. The cleanspace, 280, of this fabricator 220 may as mentioned be operated at a lower cleanliness requirement when compared to cleanspace 270.

Processing on the substrate, in the wafer form mentioned, may continue in this second cleanspace fabricator element, 220, through a variety of processing steps in a variety of testing and assembly type tools, depicted in an exemplary sense as item 225. The types of testing that may be performed include testing of transistor parameters on test devices, testing of the parametrics of other test devices that model devices or yield related structures, testing of test devices that represent circuit elements within larger devices and testing of fully formed integrated circuits for various aspects of their functionality. In addition testing on a wafer level may be performed on structures that test for the reliability aspects of the processing that has occurred. Other types of testing may involve characterizing physical aspects of the processing that has occurred on the substrate like for example physical thicknesses and roughness for example. Still other embodiments of testing may characterize defectivity aspects of the wafer processing as for example incorporated particulates, missing or extra features on the processed device or other measures of defectiveness. There may be numerous forms of testing that may occur on the substrate which has been processed in a first type of cleanspace environment.

Other processing which may occur in fabricator environment 220 may include steps which take the wafer form of substrate and create different forms of a second substrate type which may be further processed in fabricator 220. An example of such a second form may include “Dice”/“Die” or “Chips”. These items may commonly be rectilinear pieces that are cut out of the wafer form substrate. Some of the exemplary processing steps that may be performed in tools of the type that would be placed in fabricator 220 may include thinning of a wafer or die, cutting processes to create the die from the wafer form. Other examples may include polishing steps that can be performed after wafer thinning is performed. The wafers may also have various films and metals deposited on the top or bottom side of the wafer substrate for various purposes.

Other classes of wafer processing that can occur in an “assembly” portion of a multiple substrate cleanspace fabricator may relate to the general processing steps classified as “Wafer Level Packaging” steps. In these steps the thinning, coating and other processing steps to create interconnects and encapsulated package elements are all performed on a wafer level format.

Some of these steps, in other embodiments may relate to chip level packaging. For example, substrates in die form may be attached, glued, affixed or bonded to various forms of metal or insulator packaging. The packages that the dies are mounted to may typically have electrical leads that comes out of them in between insulating and hermetically sealing regions. The connection of metal lines from the integrated circuits to the package leads can occur with numerous processing including for example, wire bonding and flip chip or solder bump processing . . . in some processing conductive adhesives, epoxies or pastes may be applied. Thermal processing and annealing may be performed on the wafers, dies or packaged die forms. There may be many other types of processing standard in the art of packaging that would comprise different types of tooling in the exemplary fabricator 220.

More complex processing of the die may occur relating to various 3d packaging schemes where the end product may have in some embodiments multiple levels of die stacked upon each other. Some of the exemplary process types that drive various types of tooling for the processing include thru silicon via processing, die stacking, interposer connection and the like. As mentioned, regardless of the sophistication of the various packaging schemes, processing of substrates of a die form may occur in a cleanspace fabricator environment.

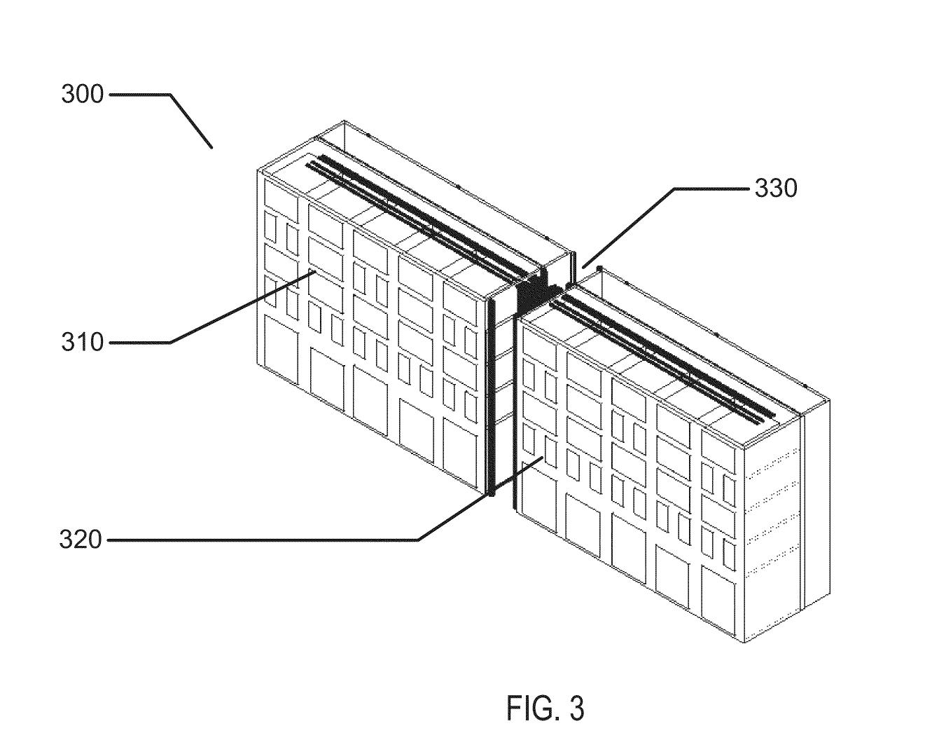

Proceeding to FIG. 3, item 300, a representation of a different way to configure a cleanspace fabricator to process different types of substrates is shown. In a similar fashion of item 200, there are two different fabricator elements for different cleanspace types. Item 310 may represent a cleanspace, in an exemplary sense, that is of high cleanliness specification, consistent with processing of integrated circuits into semiconductor substrates. Additionally, item 320 may represent the lower cleanliness specification cleanspace environment consistent with “assembly” processing. The two cleanliness environments may be formed in this embodiment type by the insertion of a physical separation, shown as item 330, with an essentially planar fabricator type. Item 330 may be as simple as a wall, or as shown may be two walls on each fabricator element side with various equipment running in between. As mentioned before there may be numerous means to establish the cleanliness of the cleanspace environment through various types and directions of airflow consistent with the art herein.

### Exemplary Types of Cleanspace Combinations to Form Collocated Composite Cleanspace Fabricators.

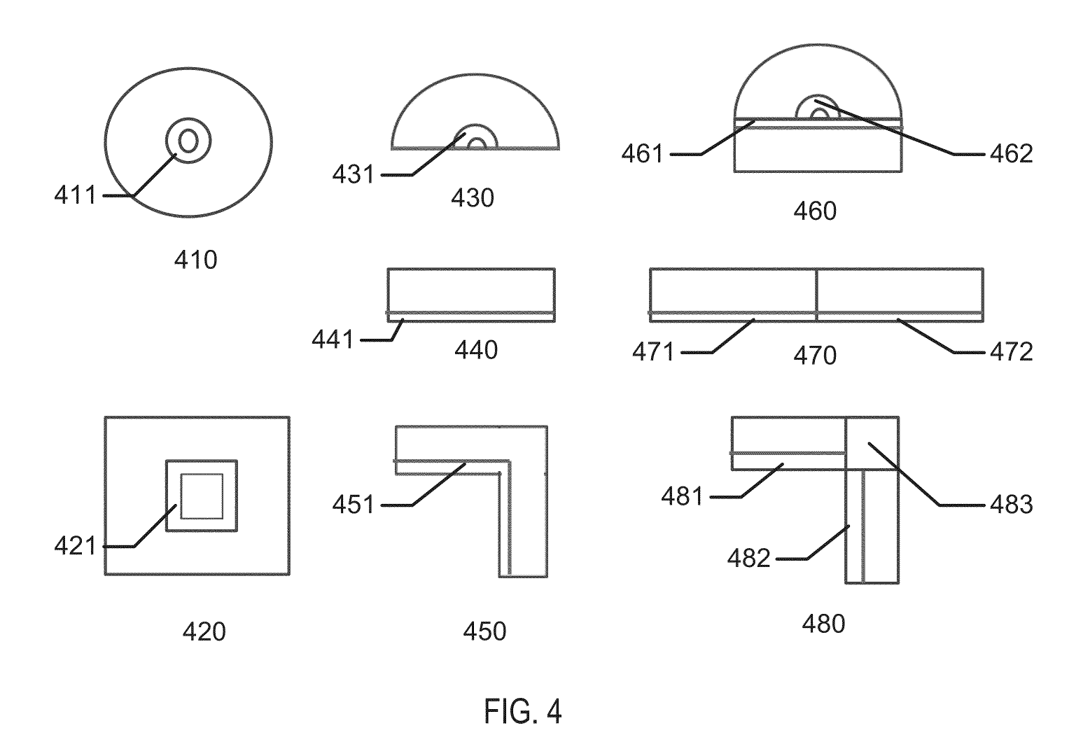

In FIG. 4, there are various embodiments of cleanspace fabricators and some exemplary derivations of those types that form fabricators with multiple cleanspace environments associated with processing substrates to different requirements of cleanliness of environment where the multiple environments are at a collocated site. Item 410 and 420 depict simple annular, tubular cleanspace fabricators. Item 410 is a round annular tubular cleanspace fabricator and item 411 may represent a typical location of a primary cleanspace in such a fabricator. Item 420 may represent a rectilinear annular tubular cleanspace fabricator with its exemplary primary cleanspace represented as item 421.

From the two basic cleanspace fabricator types, 410 and 420 a number of additional fab types may be formed by sectional cuts of the basic types. A sectional cut may result in a hemi-circular shaped fabricator, 430 with its exemplary primary cleanspace as item 431. A section cut of item 420 may result in an essentially planar cleanspace fabricator, similar to that discussed in previous figures, where the primary cleanspace is represented by item 441. And in another non-limiting example, a cleanspace fabricator of the type 450 may result from a sectional cut of type 420 where it too may have a primary cleanspace indicated by item 451.

When these various fabricator types are combined with copies of themselves or other types of cleanspace fabricators, a new type of cleanspace fabricator may result which is a composite of multiple cleanspace environments. A few of numerous combinations are depicted. For example, item 460 may represent a combination of a first fabricator of type 430 with a second fabricator of type 460. Item 461 may represent a first cleanspace environment in this composite fab, 460 and item 462 may represent a second type of cleanspace environment. Alternatively, item 470 may be formed by the combination of two versions of fabricator type 440, where the two different primary cleanspace environments are shown as items 471 and 472. This fabricator shares similarity to the type of fabricator depicted in item 300. Another exemplary result may derive from the combination of two fabricators of the type 440 as shown in item 480. Item 480 may have two different primary cleanspace regions, items 481 and 482. And, in some embodiments, item 483 may represent a third cleanspace region. It may be apparent that the generality of combining two different cleanspace elements to form a composite fabricator may be extended to cover fabs made from combinations of 3 or more fabricator cleanspace elements.

### Multiple Automation Systems in Cleanspace Environments for the Processing of Multiple Substrate Types.

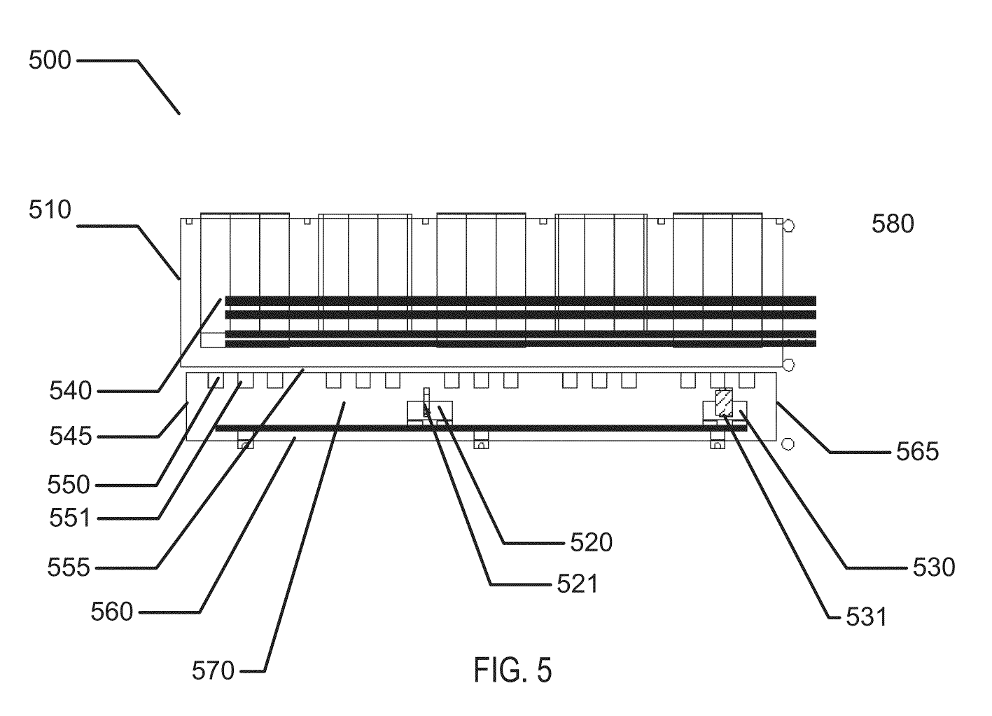

An alternative type of cleanspace environment for processing of multiple types of substrates may be represented by item 500 in FIG. 5. In a fabricator of this type, 510, there may be only one cleanspace environment represented as item 570. In some embodiments, this cleanspace may be defined by a unidirectional airflow flowed from or through wall 555 to wall 560 where walls 545 and 565 are flat walls. It may be clear that the various diversity described previously may include art consistent with the inventive art herein. And in some embodiments, there may be a tool port, 550 which resides significantly in the cleanspace, 570, which may be called a fabricator cleanspace in some embodiments, while a tool body, 540 resides outside this first cleanspace 570.

In some embodiments, the cleanliness of the cleanspace environment, 570, may be uniformly at the highest specification required for any of the processing in the fabricator environment. In such embodiments, therefore, the environment may exceed the needs of other processing steps that are performed within it. Since there may be multiple types of substrates processed in the environment, as for example wafers and die form, there may need to be two different types of automation present to move substrates from tool port to tool port. For example, item 520 may represent a robot that is capable of moving wafer carriers through the use of a robotic arm 521. And, item 530 may represent a piece of automation that is capable of moving die carriers through use of a different robotic arm 531, from tool port to tool port. In fabricators of this type, in some embodiments there may be tools that have two different types of tool port on them, one consistent with handling a first type of substrate like for example wafer carriers and another capable of handling die carriers.

In some embodiments, in a non-limiting sense, such a tool might include a tool for dicing wafer into die. In this case, carriers with wafers would be input into the tool through one port shown for example as item 550 and then die carriers may leave the tool through tool port 551.

Other manners of processing multiple substrates may include for example tools which take substrate carriers from a region external to the cleanspace fabricator like item 580 and place them into the cleanspace environment through a tool port. In a similar fashion, substrates in various types of carriers may also exit the fabricator environment through a processing tool to an external environment like 580 as well. Alternatively there may be other means to directly introduce or remove substrate carriers into the cleanspace environment directly through a cleanspace wall, for example through wall 545.

In any of the cleanspace fabricator embodiments where multiple types of substrates are processed within a single type of cleanspace environment there may be need for multiple types of automation. This may be true for the type of single fabricator environment shown in item 500 or alternatively for the composite types shown previously where multiple substrate types are processed. It may be clear, that another embodiment may derive where the automation devices, like item 520, are capable of handling multiple substrate carrier types.

Types of Carriers that may be Processed Within Composite Cleanspace Fabricators

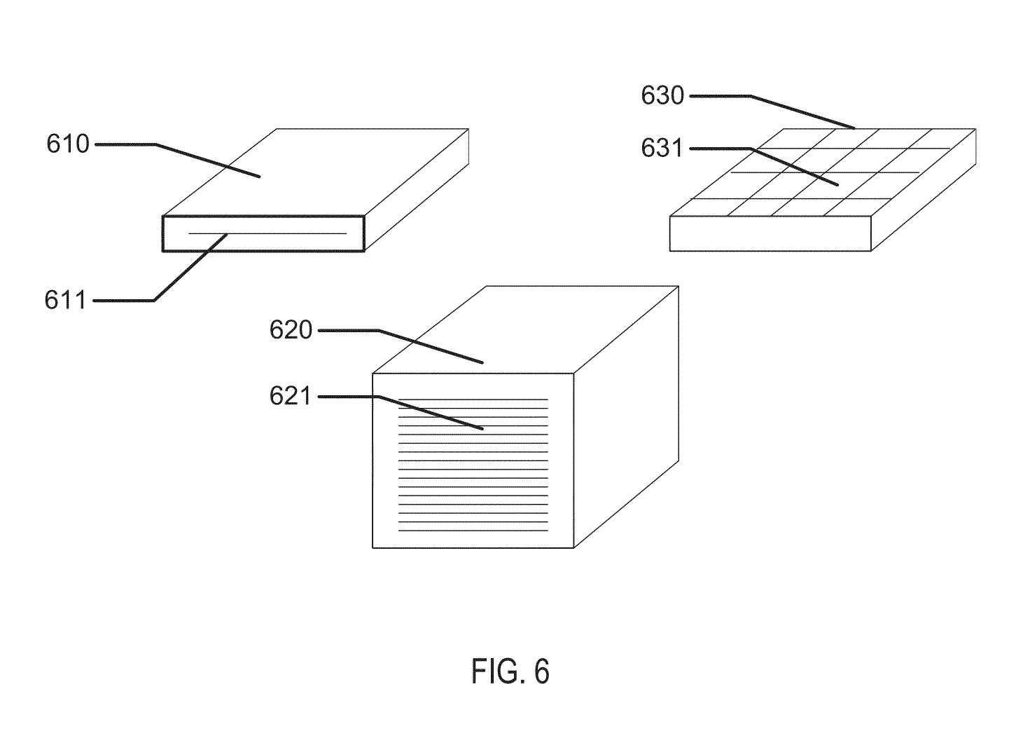

Proceeding to FIG. 6, there are a number of substrate carriers that are depicted for example. In item 610, there is depicted an exemplary substrate carrier where one, 611, substrate piece is included. In some embodiments, the substrate piece may include a semiconductor wafer where the wafer has a dimension of roughly 2 inches. In other embodiments the substrate piece may include a semiconductor wafer where the wafer has a dimension of 8, 12 or 18 inches. In still further embodiments, the substrate piece may be a round, square or sheet which includes semiconductor, metallic and/or insulating material

Other types of carriers may have the capability of containing numerous substrate pieces. For example, item 620 may represent a multiple substrate carrier where items 621 are the multiple substrates. There may be numerous types of substrates which include but are not limited to the types discussed in the previous discussion of a single substrate carrier. Some examples of such a carrier might include SMIF pods and FOUPS in the semiconductor industry.

As mentioned in the previous discussions, some substrate types may be defined from pieces of a larger substrate which has been cut into smaller segments. These pieces may be carried around in various types of carriers. An example may be a “waffle pack” 630 where the carrier has multiple wells or chambers 631 into which the segmented substrates may be placed and then carried for further processing.

It may be apparent that a cleanspace fabricator may be capable of processing numerous types of substrates where the substrate processing needs to occur in a clean environment. Although examples of certain substrates have been included, the spirit of the invention is intended to embrace the inclusion of all the different types of substrates that may be processed in a cleanspace fabricator.

### GLOSSARY OF SELECTED TERMS

Air receiving wall: a boundary wall of a cleanspace that receives air flow from the cleanspace.
Air source wall: a boundary wall of a cleanspace that is a source of clean airflow into the cleanspace.
Annular: The space defined by the bounding of an area between two closed shapes one of which is internal to the other.
Automation: The techniques and equipment used to achieve automatic operation, control or transportation.
Ballroom: A large open cleanroom space devoid in large part of support beams and walls wherein tools, equipment, operators and production materials reside.
Batches: A collection of multiple substrates to be handled or processed together as an entity
Boundaries: A border or limit between two distinct spaces—in most cases herein as between two regions with different air particulate cleanliness levels.
Circular: A shape that is or nearly approximates a circle.
Clean: A state of being free from dirt, stain, or impurities—in most cases herein referring to the state of low airborne levels of particulate matter and gaseous forms of contamination.
Cleanspace: A volume of air, separated by boundaries from ambient air spaces, that is clean.
Cleanspace Fabricator: A fabricator where the processing of substrates occurs in a cleanspace that is not a typical cleanroom, in many cases because there is not a floor and ceiling within the primary cleanspace immediately above and below each tool body's level; before a next tool body level is reached either directly above or below the first tool body.
Cleanspace, Primary: A cleanspace whose function, perhaps among other functions, is the transport of jobs between tools.
Cleanspace, Secondary: A cleanspace in which jobs are not transported but which exists for other functions, for example as where tool bodies may be located.
Cleanroom: A cleanspace where the boundaries are formed into the typical aspects of a room, with walls, a ceiling and a floor.
Cleanroom Fabricator: A fabricator where the primary movement of substrates from tool to tool occurs in a cleanroom environment; typically having the characteristics of a single level, where the majority of the tools are not located on the periphery.
Core: A segmented region of a standard cleanroom that is maintained at a different clean level. A typical use of a core is for locating the processing tools.
Dicing: A process of cutting out segments of a substrate into smaller discrete entities sometimes called chips, dice or die.
Ducting: Enclosed passages or channels for conveying a substance, especially a liquid or gas—typically herein for the conveyance of air.
Envelope: An enclosing structure typically forming an outer boundary of a cleanspace.
Fab (or fabricator): An entity made up of tools, facilities and a cleanspace that is used to process substrates.
Fabricator Cleanspace: The portion of a cleanspace fabricator where the primary movement of substrates from tool to tool occurs; which is a primary cleanspace environment that is not a cleanroom environment; typically having the characteristics of multiple levels, where the majority of the tools are located on the periphery. When there are multiple Fabricator Cleanspaces within a single location they may be separated spatially and/or have different characteristics of the primary cleanspace such as a different ambient particle level for example.
Fit up: The process of installing into a new clean room the processing tools and automation it is designed to contain.
Flange: A protruding rim, edge, rib, or collar, used to strengthen an object, hold it in place, or attach it to another object. Typically herein, also to seal the region around the attachment.
Folding: A process of adding or changing curvature.

HEPA: An acronym standing for high-efficiency particulate air. Used to define the type of filtration systems used to clean air.
Horizontal: A direction that is, or is close to being, perpendicular to the direction of gravitational force.
Job: A collection of substrates or a single substrate that is identified as a processing unit in a fab. This unit being relevant to transportation from one processing tool to another.
Laminar Flow: When a fluid flows in parallel layers as can be the case in an ideal flow of cleanroom or cleanspace air. If a significant portion of the volume has such a characteristic, even though some portions may be turbulent due to physical obstructions or other reasons, then the flow can be characterized as in a laminar flow regime or as laminar.
Logistics: A name for the general steps involved in transporting a job from one processing step to the next. Logistics can also encompass defining the correct tooling to perform a processing step and the scheduling of a processing step.
Matrix: An essentially planar orientation, in some cases for example of tool bodies, where elements are located at discrete intervals along two orthogonal axes directions.
Multifaced: A shape having multiple faces or edges.
Nonsegmented Space: A space enclosed within a continuous external boundary, where any point on the external boundary can be connected by a straight line to any other point on the external boundary and such connecting line would not need to cross the external boundary defining the space.
Perforated: Having holes or penetrations through a surface region. Herein, said penetrations allowing air to flow through the surface.
Peripheral: Of, or relating to, a periphery.
Periphery: With respect to a cleanspace, refers to a location that is on or near a boundary wall of such cleanspace. A tool located at the periphery of a primary cleanspace can have its body at any one of the following three positions relative to a boundary wall of the primary cleanspace: (i) all of the body can be located on the side of the boundary wall that is outside the primary cleanspace, (ii) the tool body can intersect the boundary wall or (iii) all of the tool body can be located on the side of the boundary wall that is inside the primary cleanspace. For all three of these positions, the tool's port is inside the primary cleanspace. For positions (i) or (iii), the tool body is adjacent to, or near, the boundary wall, with nearness being a term relative to the overall dimensions of the primary cleanspace.
Planar: Having a shape approximating the characteristics of a plane.
Plane: A surface containing all the straight lines that connect any two points on it.
Polygonal: Having the shape of a closed figure bounded by three or more line segments
Process: A series of operations performed in the making or treatment of a product—herein primarily on the performing of said operations on substrates.
Robot: A machine or device, that operates automatically or by remote control, whose function is typically to perform the operations that move a job between tools, or that handle substrates within a tool.
Round: Any closed shape of continuous curvature.
Substrates: A body or base layer, forming a product, that supports itself and the result of processes performed on it.
Tool: A manufacturing entity designed to perform a processing step or multiple different processing steps. A tool can have the capability of interfacing with automation for handling jobs of substrates. A tool can also have single or multiple integrated chambers or processing regions. A tool can interface to facilities support as necessary and can incorporate the necessary systems for controlling its processes.
Tool Body: That portion of a tool other than the portion forming its port.
Tool Port: That portion of a tool forming a point of exit or entry for jobs to be processed by the tool. Thus the port provides an interface to any job-handling automation of the tool.
Tubular: Having a shape that can be described as any closed figure projected along its perpendicular and hollowed out to some extent.
Unidirectional: Describing a flow which has a tendency to proceed generally along a particular direction albeit not exclusively in a straight path. In clean airflow, the unidirectional characteristic is important to ensuring particulate matter is moved out of the cleanspace.
Unobstructed removability: refers to geometric properties, of fabs constructed in accordance with the present invention, that provide for a relatively unobstructed path by which a tool can be removed or installed.
Utilities: A broad term covering the entities created or used to support fabrication environments or their tooling, but not the processing tooling or processing space itself. This includes electricity, gasses, airflows, chemicals (and other bulk materials) and environmental controls (e.g., temperature).
Vertical: A direction that is, or is close to being, parallel to the direction of gravitational force.

While the invention has been described in conjunction with specific embodiments, it is evident that many alternatives, modifications and variations will be apparent to those skilled in the art in light of the foregoing description. Accordingly, this description is intended to embrace all such alternatives, modifications and variations as fall within its spirit and scope.

What is claimed is:

1) A method of producing substrates; said method comprising:
fixing multiple substrate processing tools in a first matrix comprising at least two of the processing tools oriented in a vertical dimension in relation to each other wherein said multiple processing tools are at least partially located in a first fabricator cleanspace comprising a first boundary and a second boundary and each of the processing tools is capable of independent operation and removable in a discrete fashion relative to other processing tools;
fixing a second set of multiple substrate processing tools in a second matrix comprising at least two of the second processing tools oriented in a vertical dimension in relation to each other wherein said multiple processing tools are at least partially located in a second fabricator cleanspace comprising a third boundary and a fourth boundary and each of the processing tools is capable of independent operation and removable in a discrete fashion relative to other processing tools;
storing at least a first substrate in a carrier while the substrate is transported between two or more of the processing tools;
receiving the substrate carrier into a first processing tool port, wherein each tool is sealed to a respective opening in at least one of the first boundary and the second boundary;
removing the substrate from the substrate carrier into a first tool port;
performing a first process on the substrate in a first tool;
containing the substrate in the substrate carrier subsequent to the performance of the first process;
transporting the substrate carrier to a second tool port;
removing the substrate from the substrate carrier into the second tool port; and
performing a second process on the substrate in a second tool.

2) The method of claim 1 additionally comprising:
removing the substrate carrier from the first fabricator cleanspace;
placing the substrate carrier into the second fabricator cleanspace.

3) The method of claim 2 wherein:
the second fabricator cleanspace wherein substrate carriers are moved from tool ports to tool ports is a different class environment than the first fabricator cleanspace wherein substrate carriers are moved from tool ports to tool ports.

4) The method of claim 2 wherein:
the tools of the second matrix are designed to perform packaging process steps on the substrates.

5) The method of claim 4 wherein:
there are two different forms of automation to transport substrate carriers within the second fabricator cleanspace environment.

6) The method of claim 5 wherein:
the two different forms of automation comprise capability to transport two different forms of substrate carriers within the second fabricator cleanspace environment.

7) The method of claim 1 additionally comprising:
providing two different forms of automation for moving two different types of substrate carriers within the first fabricator cleanspace.

8) The method of claim 7 wherein:
the first type of substrate carrier contains semiconductor wafers; and
the second type of substrate carrier contains portions of semiconductor wafers.

9) The method of claim 1 additionally comprising:
providing a form of automation for moving at least two different types of substrate carriers within the first fabricator cleanspace.

10) The method of claim 2 additionally comprising:
fixing a third fabricator cleanspace comprising a fifth boundary and a sixth boundary;
removing the substrate carrier from the first fabricator cleanspace;
placing the substrate carrier into the third fabricator cleanspace.

11) The method of claim 4 wherein:
a tool in the second matrix performs a reactive ion etch step to form through silicon vias.

12) The method of claim 4 wherein:
a tool in the second matrix performs an electrical test process upon the substrate.

13) The method of claim 4 wherein:
a tool in the second matrix performs a solder reflow process.

14) The method of claim 4 wherein:
a tool in the second matrix performs a substrate grinding process.

15) The method of claim 4 wherein:
a tool in the second matrix performs a substrate polishing process.

16) The method of claim 4 wherein:
a tool in the second matrix performs an epoxy coating process.

17) The method of claim 4 wherein:
a tool in the second matrix performs a wire bonding process.

18) The method of claim 10 wherein:
a tool in the second matrix performs a dicing process.

19) A method of producing substrates; said method comprising:
fixing multiple substrate processing tools in a first matrix comprising at least two of the processing tools oriented in a vertical dimension in relation to each other wherein said multiple processing tools are at least partially located in a fabricator cleanspace comprising a first boundary and a second boundary and each of the processing tools is capable of independent operation and removable in a discrete fashion relative to other processing tools;
storing at least a first substrate in a carrier while the substrate is transported between two or more of the processing tools;
receiving the substrate carrier into a first processing tool port, wherein each tool is sealed to a respective opening in at least one of the first boundary and the second boundary;
removing the substrate from the substrate carrier into the first tool port;
performing a first process on the substrate in the first tool;
containing the substrate in the substrate carrier subsequent to the performance of the first process; transporting the substrate carrier to a second tool port;
removing the substrate from the substrate carrier into the second tool port; and
performing a dicing process on the substrate in the second tool.

20) method of claim 2 additionally comprising:
removing a substrate carrier from a second fabricator cleanspace to an environment external to any fabricator cleanspace.
